(19) United States
(12) Patent Application Publication
(10) Pub. No.: US 2026/0163342 A1
(43) Pub. Date: Jun. 11, 2026

(54) ELECTRIC VEHICLE

(71) Applicant: ISUZU MOTORS LIMITED, Yokohama-shi (JP)

(72) Inventors: Takuma HAKUTO, Fujisawa-shi (JP); Isao OHARA, Fujisawa-shi (JP); Tomohiro KORENAGA, Fujisawa-shi (JP)

(21) Appl. No.: 19/390,869

(22) Filed: Nov. 17, 2025

(30) Foreign Application Priority Data
Dec. 10, 2024 (JP) 2024-215341

(51) Int. Cl. H02G 3/03; H01F 27/26; H01R 13/52

(52) U.S. Cl. CPC H02G 3/03; H01F 27/266; H01R 13/5213; H01R 2201/26

(57) ABSTRACT

Provided is an electric vehicle including: an inverter; a high-voltage cable connected to the inverter; and a ferrite core provided at the high-voltage cable. The high-voltage cable is disposed at a position at which condensation water generated at a vehicle component is supplied from the vehicle component to the ferrite core.

### CROSS REFERENCE TO RELATED APPLICATIONS

This application is entitled to (or claims) the benefit of Japanese Patent Application No. 2024-215341, filed on Dec. 10, 2024, the disclosure of which including the specification, drawings and abstract is incorporated herein by reference in its entirety.

### TECHNICAL FIELD

The present invention relates to an electric vehicle.

### BACKGROUND ART

In a high-voltage cable connected to an inverter of an electric vehicle, common mode noise generated by switching of a power semiconductor of the inverter may spread to the entire vehicle through a housing of a motor and the inverter and may be input to the inverter through the high-voltage cable. In order to suppress this entry of common mode noise into an inverter, a ferrite core is attached to a high-voltage cable (for example, see Patent Literature (hereinafter referred to as “PTL”) 1).

The ferrite core attached to the high-voltage cable of the electric vehicle generates heat due to the following factors. One factor is that the current flowing through the high-voltage cable generates heat due to the resistance of the cable, and the heat is conducted to the ferrite core. In addition, another factor is that the ferrite core absorbs common mode noise and converts energy thereof into heat. Note that, the ferrite core can be kept within the operating temperature range even when the ferrite core generates heat.

### CITATION LIST

### Patent Literature

### PTL 1

Japanese Patent Application Laid-Open No. 2020-058149

### SUMMARY OF INVENTION

### Technical Problem

When a ferrite core attached to a high-voltage cable of an electric vehicle is continuously used at a high temperature even within the operating temperature range, deterioration of the ferrite core may be accelerated in comparison with a case where the ferrite core is continuously used at a low temperature.

The present invention has been made in view of such a problem, and an object thereof is to provide an electric vehicle capable of suppressing acceleration in deterioration of a ferrite core attached to a high-voltage cable.

### Solution to Problem

The electric vehicle of the present invention includes: an inverter; a high-voltage cable connected to the inverter; and a ferrite core provided at the high-voltage cable. The high-voltage cable is disposed at a position at which condensation water generated at a vehicle component is supplied from the vehicle component to the ferrite core.

### Advantageous Effects of Invention

According to the electric vehicle of the present invention, it is possible to suppress acceleration in deterioration of a ferrite core attached to a high-voltage cable by cooling the ferrite core with condensation water and to improve the reliability.

### BRIEF DESCRIPTION OF DRAWINGS

FIG. 1 is a diagram illustrating an outline of an attachment structure of a high-voltage cable attached to an electric vehicle in Embodiment 1 of the present invention;

FIG. 2 is a diagram illustrating details of the attachment structure of the high-voltage cable in Embodiment 1 of the present invention;

FIG. 3 is a diagram illustrating details of an attachment structure of the high-voltage cable in Embodiment 2 of the present invention;

FIG. 4 is a diagram illustrating details of an attachment structure of the high-voltage cable in Embodiment 3 of the present invention; and

FIG. 5 is a diagram illustrating details of an attachment structure of the high-voltage cable in Embodiment 4 of the present invention.

### DESCRIPTION OF EMBODIMENTS

Hereinafter, embodiments of the present invention will be described in detail with reference to the accompanying drawings.

### Embodiment 1

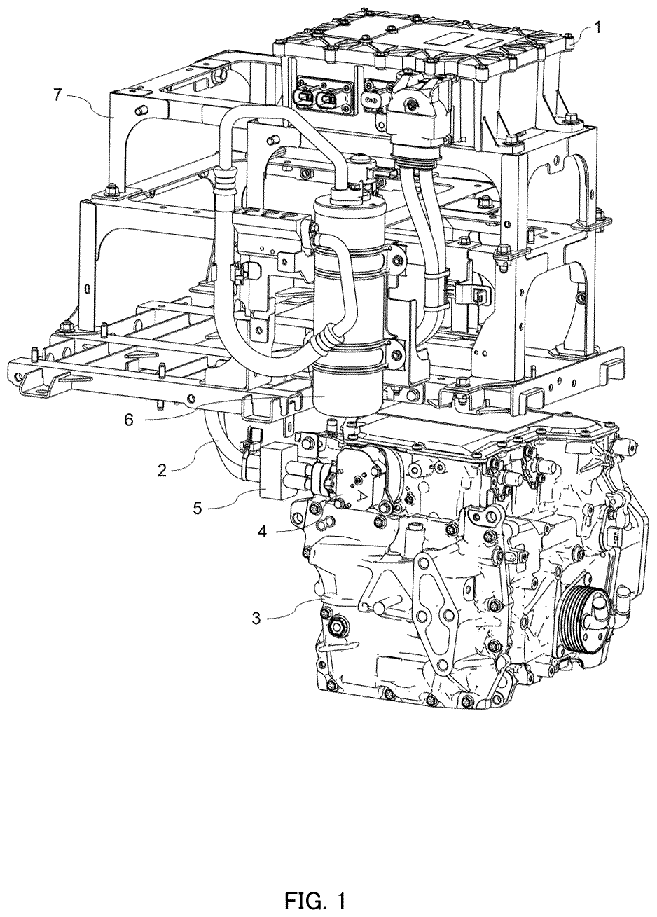

First, an outline of an attachment structure of a high-voltage cable in an electric vehicle in Embodiment 1 of the present invention will be described with reference to FIG. 1. FIG. 1 is a diagram illustrating an outline of the attachment structure of the high-voltage cable attached to the electric vehicle in Embodiment 1 of the present invention.

The electric vehicle in Embodiment 1 includes: junction box 1, high-voltage cable 2, eAxle 3, connector 4, ferrite core 5, accumulator 6, and frame 7. Junction box 1 receives high-voltage power supplied from a battery (not illustrated) and distributes the power to a plurality of high-voltage cables. High-voltage cable 2 transmits the high-voltage power output from junction box 1 to eAxle 3. The power supplied from high-voltage cable 2 is received by eAxle 3 which then converts the power into a driving force. Connector 4 connects high-voltage cable 2 to eAxle 3. Ferrite core 5 is attached to high-voltage cable 2 immediately near connector 4. Accumulator 6 is a component of a vehicle air conditioning apparatus (in-vehicle air conditioning system) (not illustrated) and is fixed directly above ferrite core 5. Frame 7 is disposed above eAxle 3 and fixes junction box 1 and accumulator 6.

In eAxle 3, an inverter (not illustrated) and a motor (not illustrated) are incorporated, and eAxle 3 converts, with the inverter, DC power supplied from high-voltage cable 2 into AC power, and converts, with the motor, the AC power to a driving force. High-voltage cable 2 is connected to the inverter in eAxle 3.

Ferrite core 5 suppresses common mode noise spreading from the inverter in eAxle 3 to the entire vehicle and returning to the inverter through high-voltage cable 2. Ferrite core 5 is provided vertically below accumulator 6.

Accumulator 6 separates a refrigerant in the air conditioning apparatus into liquid and gas. Further, what is disposed directly above ferrite core 5 is not confined to accumulator 6, and, for example, a vehicle component, such as an evaporator in the vehicle air conditioning apparatus, on the surface of which condensation water is generated, may be disposed directly above ferrite core 5.

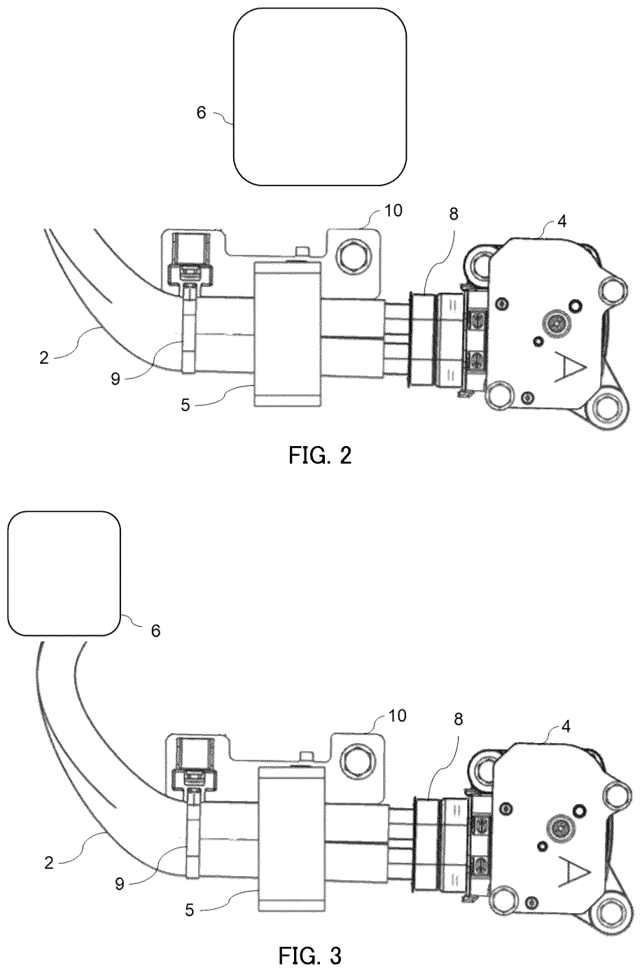

Next, a method for fixing ferrite core 5 in Embodiment 1 of the present invention will be described with reference to FIG. 2. FIG. 2 is a diagram illustrating details of the attachment structure of high-voltage cable 2 in Embodiment 1 of the present invention.

As illustrated in FIG. 2, high-voltage cable 2 includes connector stopper 8, cable stopper 9 and pedestal 10. Connector stopper 8 is disposed in a connection portion between high-voltage cable 2 and connector 4. Cable stopper 9 is disposed immediately near ferrite core 5 and on the side of junction box 1 with respect to ferrite core 5. Pedestal 10 is disposed adjacent to ferrite core 5 and connector stopper 8.

Connector stopper 8 prevents ferrite core 5 from being shifted to the connector side and from coming off the tube of high-voltage cable 2. Cable stopper 9 prevents ferrite core 5 from being shifted to high-voltage cable 2 on the side of junction box 1. Pedestal 10 is capable of keeping the portion of high-voltage cable 2, to which ferrite core 5 is attached, level by fixing the position of cable stopper 9, and prevents the position of ferrite core 5 from being shifted.

As described above, ferrite core 5 is disposed directly below accumulator 6. For this reason, when an occupant uses the air conditioning apparatus and condensation water is generated on the surface of accumulator 6, the condensation water drips to ferrite core 5 and ferrite core 5 is cooled.

### Embodiment 2

Next, an attachment structure of the high-voltage cable attached to the electric vehicle in Embodiment 2 of the present invention will be described with reference to FIG. 3. FIG. 3 is a diagram illustrating details of an attachment structure of the high-voltage cable in Embodiment 2 of the present invention. Note that, the electric vehicle in Embodiment 2 is different from the electric vehicle in Embodiment 1 in that accumulator 6 is disposed directly above high-voltage cable 2.

As illustrated in FIG. 3, accumulator 6 is disposed directly above high-voltage cable 2 on the side of junction box 1 with respect to ferrite core 5. For this reason, it is possible to suppress the influence of heat to ferrite core 5 attached to high-voltage cable 2 by cooling high-voltage cable 2 with condensation water.

### Embodiment 3

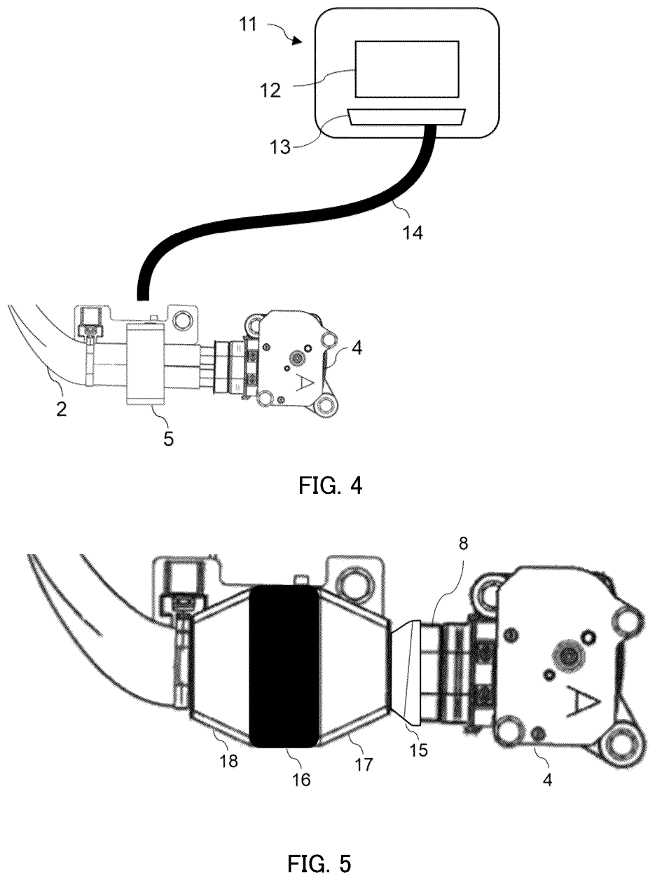

Next, a structure for guiding condensation water to ferrite core 5 in Embodiment 3 of the present invention will be described with reference to FIG. 4. FIG. 4 is a diagram illustrating details of an attachment structure of the high-voltage cable in Embodiment 3. Note that, the electric vehicle in Embodiment 3 is different from the electric vehicle in Embodiment 1 in terms of further including drain hose 14.

As illustrated in FIG. 4, air conditioner unit 11 includes evaporator 12 and drain pan 13. Drain pan 13 is disposed directly below evaporator 12. Drain hose 14 is connected to drain pan 13. The outlet of drain hose 14 is disposed directly above ferrite core 5.

Air conditioner unit 11 integrates the respective functions of cooling and heating the interior air of the vehicle, ventilating the vehicle, and performing air purification in the vehicle to perform efficient management thereof. When the refrigerant evaporates, evaporator 12 absorbs heat from the surrounding air to cool the interior air of the vehicle. Condensation water is generated on the surface of evaporator 12 in the process of cooling the air. Drain pan 13 collects the condensation water generated at evaporator 12. Drain hose 14 guides the condensation water collected by drain pan 13 to ferrite core 5.

By guiding the condensation water to ferrite core 5 with drain hose 14, it is possible to change the dripping position of the condensation water. For this reason, the degree of freedom in the positional design of ferrite core 5 improves.

### Embodiment 4

Next, a method for rendering connector 4 waterproof in Embodiment 4 of the present invention will be described with reference to FIG. 5. FIG. 5 is a diagram illustrating details of an attachment structure of the high-voltage cable in Embodiment 4 of the present invention. The electric vehicle in Embodiment 4 is different from the electric vehicle in Embodiment 1 in that a waterproof sheet is wound around ferrite core 5.

As illustrated in FIG. 5, connector tape 15 is first half-lapped (which involves overlapping every turn by half the width of connector tape 15) so as to cover part of connector stopper 8 disposed in the connection portion between high-voltage cable 2 and connector 4 as well as part of the tube of high-voltage cable 2. Next, waterproof sheet 16 is wound around ferrite core 5. Then, connector-side ferrite core tape 17 is stuck so as to cover part of waterproof sheet 16 and part of connector tape 15. Finally, junction box-side ferrite core tape 18 is stuck so as to cover part of waterproof sheet 16 and part of high-voltage cable 2.

By protecting ferrite core 5 and the connection portion between high-voltage cable 2 and connector 4 with the tapes and the sheet, it is possible to prevent condensate water, which has dripped to ferrite core 5, from flowing into connector 4 along high-voltage cable 2.

### Summary

In summary, the electric vehicle of the present invention includes: an inverter, a high-voltage cable 2 connected to the inverter; and ferrite core 5 provided at high-voltage cable 2, and high-voltage cable 2 is disposed at a position at which condensation water generated at a vehicle component is supplied from the vehicle component to ferrite core 5. For this reason, it is possible to suppress acceleration in deterioration of ferrite core 5 attached to high-voltage cable 2 by cooling ferrite core 5 with condensation water and to improve the reliability.

In addition, in the case of an electric vehicle in which high-voltage cable 2 or ferrite core 5 is attached directly below accumulator 6, it is possible to cool ferrite core 5 by the dripping of condensation water generated at accumulator 6 to ferrite core 5. In particular, in a case where the outside air temperature of the vehicle is high, there is concern that ferrite core 5 will have a high temperature. In such a case, the driver of the vehicle often operates the air conditioner during the operation of the vehicle, and accumulator 6 of the air conditioner operates and condensation water is likely to be generated. For this reason, by attaching high-voltage cable 2 and ferrite core 5 such that ferrite core 5 is located directly below accumulator 6 of the air conditioner, it is possible to obtain an effect that ferrite core 5 is easily cooled in conjunction with the air temperature of the vehicle. Accordingly, it is possible to cool ferrite core 5 without introducing any special apparatus in a limited space of the vehicle.

Further, in the case of an electric vehicle including drain hose 14, drain hose 14 guides condensation water to ferrite core 5. For this reason, it is possible to change the dripping position of condensation water. Accordingly, the degree of freedom in the positional design of high-voltage cable 2 and ferrite core 5 improves.

Further, in the case of an electric vehicle in which a waterproof sheet is wound around ferrite core 5, the connection portion between high-voltage cable 2 and the inverter and ferrite core 5 are integrally covered with a waterproof shield. For this reason, by protecting the connection portion between high-voltage cable 2 and connector 4 with a protection member, it is possible to prevent condensation water, which has dripped to ferrite core 5, from flowing into connector 4 along high-voltage cable 2.

### INDUSTRIAL APPLICABILITY

The electric vehicle of the present invention can be suitably utilized as a passenger car, a commercial vehicle and a vehicle of a public transportation or the like.

### REFERENCE SIGNS LIST

1 Junction box
2 High-voltage cable
3 eAxle
4 Connector
5 Ferrite core
6 Accumulator
7 Frame
8 Connector stopper
9 Cable stopper
10 Pedestal
11 Air conditioner unit
12 Evaporator
13 Drain pan
14 Drain hose
15 Connector tape
16 Waterproof sheet
17 Connector-side ferrite core tape
18 Junction box-side ferrite core tape

1. An electric vehicle, comprising:
an inverter;
a high-voltage cable connected to the inverter; and
a ferrite core provided at the high-voltage cable, wherein the high-voltage cable is disposed at a position at which condensation water generated at a vehicle component is supplied from the vehicle component to the ferrite core.

2. The electric vehicle according to claim 1, wherein:
the vehicle component is an accumulator of a vehicle air conditioning apparatus, and
the ferrite core is attached directly below the accumulator.

3. The electric vehicle according to claim 1, wherein:
the vehicle component includes a drain hose, and
the drain hose guides the condensation water to the ferrite core.

4. The electric vehicle according to claim 1, wherein
a connection portion between the high-voltage cable and the inverter and the ferrite core are integrally covered with a waterproof shield.
